(19) United States
(12) Patent Application Publication
(10) Pub. No.: US 2016/0278346 A1
(43) Pub. Date: Sep. 29, 2016

(54) METHOD AND APPARATUS FOR A REMOTELY MANAGED ANIMAL COLLAR LOCK

(71) Applicant: WolfGIS, LLC, Pell City, AL (US)

(72) Inventors: JOHN MICHAEL GOLDEN, Pell City, AL (US); TEMPLETON BRIGGS, III, Snohomish, WA (US)

(73) Assignee: WolfGIS, LLC, Pell City, AL (US)

(21) Appl. No.: 15/080,295

(22) Filed: Mar. 24, 2016

Related U.S. Application Data
(60) Provisional application No. 62/137,309, filed on Mar. 24, 2015.

(51) Int. Cl. A01K 27/00

(52) U.S. Cl. CPC A01K 27/005; A01K 27/001

(57) ABSTRACT

An electro-mechanical animal collar locking clasp with open and close sensors is described that allows a communication device with a unique collar identifying code to lock and unlock the collar. The forced opening of the collar clasp would be detected by the clasp sensors initiating a response to render the collar inoperable.

### CROSS-REFERENCES TO RELATED APPLICATIONS

This application claims the benefit of U.S. Provisional Application No. 62/137,309, filed Mar. 24, 2015, which is incorporated herein by reference in its entirety.

### FIELD OF THE INVENTION

The present invention is generally directed toward an apparatus for a remotely managed animal collar lock. Further, it is directed toward a method for a remotely managed animal collar lock.

### BACKGROUND OF THE INVENTION

Intelligent animal collars are known in the art and can be used for tracking, containment, controlled movement, training, communication, vision, and any number of other uses. Many of these devices can be controlled via a smart mobile device application. For example, U.S. Pat. No. 9,258,982 to Golden, et al., discloses an animal collar that controls and confines an animal within a predefined boundary. Additionally, U.S. Pat. No. 5,857,433 to Files discloses a device for controlling an animal's movement using a collar to provide a physical stimulus and/or audible cue.

As humans' daily routines become more and more application based, the demand and popularity of intelligent animal collars that interact with smart mobile devices has been increasing. However, the increased popularity of these devices, as well as, the high dollar value associated with ownership, create a need to protect such devices from theft.

### SUMMARY OF THE INVENTION

An electro-mechanical, battery powered, microprocessor controlled locking clasp on an animal collar is disclosed. The microprocessor has a unique identification code, typically residing in non-volatile memory, which links a specific collar to a communication device, such as smart mobile phone or pad, or a proprietary device. The communication device uses a method of communication, such as, cell, WiFi, Bluetooth, or other radio system, to send a lock or unlock command from the communication device to the collar causing the microprocessor to execute the command. The locking clasp contains sensors capable of discerning whether the clasp is open or closed, and any opening of the clasp outside of receiving a valid Open command results in an appropriate message being sent to the communication device.

Collar message transmission regarding an open or unlocked clasp without receipt of an Open command will only be sent to the unique collar identifying code associated communication device. A collar that has its clasp opened without receiving a valid Open command can render itself inoperative other than to reconnect with the valid owner, for any or all functionality, including mechanically preventing the clasp from being closed.

### BRIEF DESCRIPTION OF THE DRAWINGS

Further advantages of the invention will become apparent by reference to the detailed description of preferred embodiments when considered in conjunction with the drawings:

FIG. 1 depicts a general communication system diagram showing how an electro-mechanical collar clasp on an animal collar with an open/closed sensor and lock/unlock mechanism communicates with communication devices with and without unique collar identification codes.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

This invention solves the theft problem by only allowing the registered owner of the collar 9 to open the collar clasp 2, rendering the collar and/or the clasp 2 inoperable should it be forced open by someone other than the owner.

More specifically, a collar purchaser registers a collar with the vendor, and the vendor enables the collar 9 to only respond to a specific communication device 3 or set of devices which will be used to control or manage the collar 9. The communication device 3 is linked to the collar 9 using a unique collar identifying code 5 permanently stored in the collar 9 or any other method of verifying a valid match between the collar 9 and the communication device 3. If the collar clasp 2 is stolen by forcing it open, the clasp sensor would detect the motion and execute any number of possible actions to render the collar 9 inoperable to the thief, including without limitation, prevention of clasp 2 closure and blocking elements of collar 9 functionality (but not the ability to re-link to the owner).

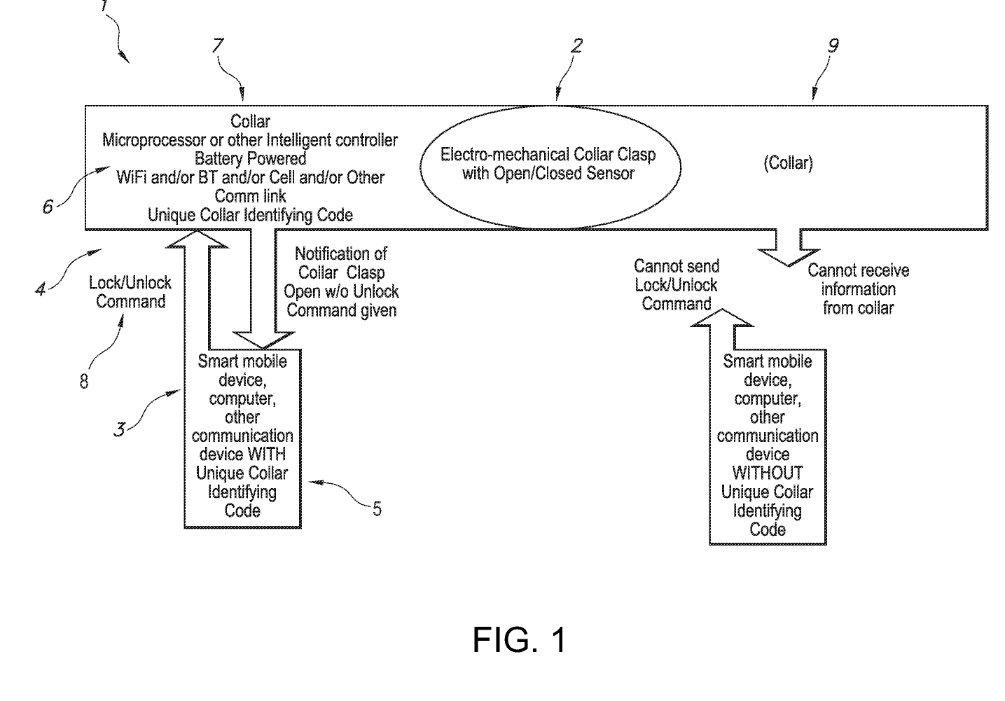

Referring to the drawings, FIG. 1. illustrates the communication of a unique collar identifying code 5 between an electro-mechanical collar locking clasp 2 on an animal collar 9 and a communication device 3.

The preferred embodiment of the device is an animal collar 9 with an electro-mechanical, battery powered microprocessor controlled locking clasp 2 which consists of a locking/unlocking mechanism 4, a communication device 3, and a method of communication 6.

After purchasing the intelligent animal collar 9, the vendor registers the animal collar to the individual purchaser's separately purchased communication device 3 with a unique collar identifying code 5 which is permanently stored in the collar 9 and allows the collar 9 to only be operated via commands from the individual purchaser's communication device 3, such as a smart phone. In this preferred embodiment, the collar identifying code 5 resides in non-volatile memory, and the smart phone can run an application that allows the user to interact with the collar 9 by using valid lock and unlock commands. Therefore, the individual's communication device 3 controls the actions of the locking/unlocking mechanism 4 of the animal collar 9 by sending lock or unlock commands 8 to the collar 9 causing the microprocessor 7 to execute the open/close commands and lock or unlock the clasp 2.

The mechanism of action utilized in this embodiment to open and close the locking clasp 2 uses any sensor (i.e., Hall effect) capable of discerning whether the latch is opened or closed. Alternatively, the individual with the unique identifying code 5 can also lock the collar 9 by physically locking it manually.

In the preferred embodiment, if an individual other than the individual who purchased and registered the collar 9 with the vendor, tries to force open the collar 9 or unlock the collar 9 using open/close commands from an application on their communication device, the collar 9 will not open or unlock because the individual's device does not have the unique collar identifying code 5 and is thus not linked to the collar 9. Any opening of the clasp 2 outside of it receiving a valid Open command 8 from a linked communication device 3 results in an appropriate message being sent to the communication device 3 and actions initiated to render the collar 9 inoperable.

The sensor response actions can include preventing clasp 2 closure and blocking elements of collar 9 functionality (but not the ability to re-link to the owner) when an invalid command is received from a device not linked to the collar or when the collar 9 is forced open.

For example, if a thief tries to steal the expensive intelligent animal collar 9 off of an animal left in its backyard or outside while it's owner goes into a store, the collar will not work unless and until it receives an action from the animal owner's communication device with the identifying code 5, rendering the intelligent animal collar 9 useless to the thief.

The separate purchased communication devices that can be used by the individual animal owner to interface with the collar 9, include without limitation, a smart mobile phone or pad, computer, or proprietary radio system. These devices can run an application which allows for communication between the device 3 and the collar 9.

The communication device 3 can communicate to the collar 9 by various available methods, including but not limited to, cell, WiFi, Bluetooth, or other radio system.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A remotely managed animal collar lock comprising:
a. a locking clasp with a locking and unlocking mechanism and sensors capable of discerning whether the latch is open or closed;
b. a microprocessor for controlling said locking clasp; and
c. a communication device capable of communicating with the animal collar and locking and unlocking said collar.

2. The communication device of claim 1 wherein said device is a smart mobile phone.

3. The communication device of claim 1 wherein said device is a smart mobile pad.

4. The communication device of claim 1 wherein said device is a proprietary device.

5. The communication method of claim 1 wherein said device communicates via WiFi.

6. The communication method of claim 1 wherein said device communicates via Bluetooth.

7. The device of claim 1 wherein said collar is battery-powered.

8. A method for locking an animal collar and preventing theft comprising the steps of:
a. registering said collar to the owner using a unique identifying code; and
b. rendering the collar inoperable to a thief when forced open.

9. The identifying code of claim 8 residing in non-volatile memory.

10. The method of claim 8 wherein the inoperability includes preventing the clasp from closing.

11. The device of claim 8 wherein the inoperability includes blocking elements of collar functionality but not the ability to re-link the owner.
